(19) United States
(12) Patent Application Publication
(10) Pub. No.: US 2012/0246719 A1
(43) Pub. Date: Sep. 27, 2012

(54) SYSTEMS AND METHODS FOR AUTOMATIC DETECTION OF NON-COMPLIANT CONTENT IN USER ACTIONS

(75) Inventors: Anuradha Bhamidipaty, Bangalore (IN); Anubha Verma, Bangalore (IN)

(73) Assignee: INTERNATIONAL BUSINESS MACHINES CORPORATION, Armonk, NY (US)

(21) Appl. No.: 13/052,676

(22) Filed: Mar. 21, 2011

(51) Int. Cl. G06F 21/00

(52) U.S. Cl. 726/22

(57) ABSTRACT

Described herein are methods, systems, apparatuses and products for automatic detection of non-compliant content in user actions. An aspect provides a method including, responsive to receiving a user selection to share data via an electronic device, analyzing the data to be shared; and automatically identifying non-compliant content within the data prior to sharing the data. Other embodiments are disclosed.

### FIELD OF THE INVENTION

The subject matter presented herein generally relates to detection of non-compliant content in user actions related to communication.

### BACKGROUND

A large amount of data, often sensitive and/or confidential, is handled each day. Various sharing actions are performed, such as live sharing, printing, displaying, projecting, e-mailing, instant messaging, and the like, on selected content of the data. As some content within the data may be sensitive/confidential, for example a work-in-progress not ready to be shared with others, it should not be freely shared. Often unknowingly sensitive/confidential data is shared when it should not be, such as when it is shared with individuals or entities that are not authorized to access it. This is especially the case when sensitive/confidential content is embedded within data. Currently the onus is on the person sharing the data to do all checks to ensure confidential/sensitive content is not released in a non-compliant way.

### BRIEF SUMMARY

One aspect provides a computer program product comprising: a computer readable storage medium having computer readable program code embodied therewith, the computer readable program code comprising: computer readable program code configured to, responsive to receiving a user selection to share data, analyze the data to be shared; and computer readable program code configured to automatically identify non-compliant content within the data prior to sharing the data.

Another aspect provides a method comprising: responsive to receiving a user selection to share data via an electronic device, analyzing the data to be shared; and automatically identifying non-compliant content within the data prior to sharing the data.

A further aspect provides a system comprising: at least one processor; and a memory device operatively connected to the at least one processor; wherein, responsive to execution of program instructions accessible to the at least one processor, the at least one processor is configured to: responsive to receiving a user selection to share data, analyze the data to be shared; and automatically identify non-compliant content within the data prior to sharing the data.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example system overview for automatic detection of non-compliant content in user actions.

FIG. 2 illustrates an example content modification engine.

FIG. 3 illustrates an example method for identifying non-compliant content.

FIG. 4 illustrates an example method for identifying non-compliant content and obtaining user feedback.

FIG. 5 illustrates an example of identifying non-compliant content.

FIG. 6 illustrates an example computing device.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the claims, but is merely representative of those embodiments.

Reference throughout this specification to “embodiment(s)” (or the like) means that a particular feature, structure, or characteristic described in connection with the embodiment is included in at least one embodiment. Thus, appearances of the phrases “according to embodiments” or “an embodiment” (or the like) in various places throughout this specification are not necessarily all referring to the same embodiment.

Furthermore, the described features, structures, or characteristics may be combined in any suitable manner in different embodiments. In the following description, numerous specific details are provided to give a thorough understanding of example embodiments. One skilled in the relevant art will recognize, however, that aspects can be practiced without certain specific details, or with other methods, components, materials, et cetera. In other instances, well-known structures, materials, or operations are not shown or described in detail to avoid obfuscation.

An embodiment provides for automatic detection of non-compliant content in user actions. As a non-limiting example, a user may be face with a request to share a slide presentation with a potential business partner, where only internal presentations have been prepared that contain confidential information that cannot be shared with the potential business partner. The task for the user is to identify a presentation that is suitable for sharing. An embodiment will allow, in real-time, the user to provide a suitable presentation in which any confidential (non-compliant) data has been modified (masked or removed). This may be accomplished automatically or interactively (for example, via use of recommendations for modifications).

The description now turns to the figures. The illustrated example embodiments will be best understood by reference to the figures. The following description is intended only by way of example and simply illustrates certain example embodiments representative of the invention, as claimed.

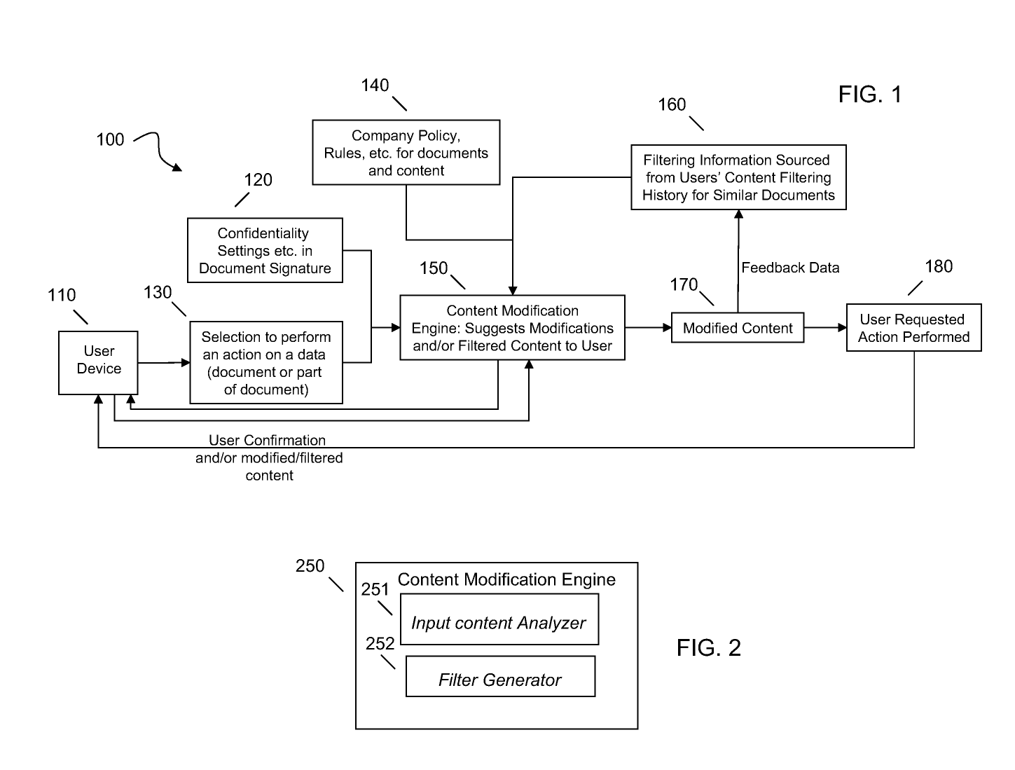

FIG. 1 illustrates an example system architecture at a macro level. As will be recognized by those having ordinary skill in the art, implementation details include basic data structures and procedures, such as look-up tables, decision trees, string search, et cetera. Thus, these will not be elaborated on here.

A non-limiting example embodiment will be described with a focus on electronic mail (e-mail) as the medium of information communication. However, the medium may be any suitable medium for sharing, such as instant messaging/chatting programs, projecting slides during a meeting, sharing via remote-desktop applications, net-meeting applications, printing out documents for presentations, files sent via chatting programs, sharing via WINDOWS/OS sharing, et cetera. WINDOWS is a registered trademark of Microsoft Corporation in the United States and other countries.

In the specific, non-limiting example embodiment illustrated in FIG. 1, the implementation of a non-compliance checking system 100 in the e-mail domain may be accomplished by way of a plugin that is invoked when an action of sharing is performed. A sharing action in this context may include, for example, a user clicking a “send” button in an e-mail client or application. Other sharing actions are therefore apparent for the given context, such as a user selection to print a document, or send a document or text via a chat program, or the like. This plugin may be integrated as an e-mail agent, for example, in a similar way as a spell-checking agent is invoked whenever an email is ready to be sent.

When a user is performing a sharing action on some data 130, such as sending an e-mail with an attachment (or sending a document attached to an email to a printer, et cetera), the system 100 checks, via content modification engine 150, if there is any non-compliant content contained within the data to be shared. This check may be implemented by accessing rules, based in whole or in part on confidentiality settings 120, company policies 140, user histories 160, and the like, as stored in appropriate storage devices accessible to content filtering engine 150.

The system 100 automatically identifies any non-compliant content within the data. At least one predetermined rule drives the decision as to whether content is identified as non-compliant. If the system 100 identifies any non-compliant content, the system 100 may provide an appropriate recommendation for how the user should deal with the non-compliant content contained within the document prior to sharing it, or the system may automatically implement a remedial action. Such a process may include automatically modifying the non-compliant content identified 170 prior to performing the use requested sharing action 180. When the modification and/or recommendation is provided, the user's sharing action will be performed 180 and feedback may be provided and stored in a repository 160 that may be accessed in the future, as further described herein.

Two main components in the example system 100 illustrated in FIG. 1 include a content modification engine 150 and an “interface”, such as provided at user device 110, to user application(s) through which exchange of information takes place. As an example, the interface to user application(s) includes a component that ensures that the functionality (such as functionality of content modification engine 150) is hidden from the user to some extent, and the user may use the usual information exchange mediums (such as e-mail) that he or she is accustomed to transparently or semi-transparently. An embodiment thus appropriately utilizes an interface such as an e-mail plugin described above with the user application(s) and enables capabilities that may include any or all of a trigger, data extraction, suggestions/recommendations, and/or modification(s). As described herein, some or all of these may take place transparently to the user.

When a user starts performing an action of sharing data via the appropriate application, the interface 110 raises a trigger to the content modification engine 150. For example, when a user attempts to send an e-mail with an attached document, the interface raises a trigger to the content modification engine 150. The interface may also transfer information, such as the data to be analyzed (electronic document, text or “body” of email message, user identification, and the like) directly to the content modification engine 150. Before or after the content modification engine 150 has performed the modification to the data, the suggestion or recommendation is optionally communicated back to the user via the interface. If such a notification is communicated to the user, this is one aspect that the end user sees and may interact with. Thus, the interface operates with different applications at the operating system (OS) or application level to check for compliance and present the recommendations and/or results of modification to the user.

Referring to FIG. 2, the content modification engine 250 includes an input content analyzer 251 and a filter generator 252. The input content analyzer 251 analyzes the content to identify non-compliant content, as ascertained via rule(s). The filter generator 252 filters/modifies content and/or provides a recommendation for handling any non-compliant content identified, as indicated via modification rule(s). The content modification engine 250 thus acts as a computation center and may be based on an intelligent combination of information extraction from the interface and relevant look-ups from system components such as 120, 140, and/or 160.

The content modification engine 150 utilized rule(s) for handling content. The rules may be based on input such as user(s) involved (for example, sender/recipient) in the sharing, device(s) involved in the sharing, the content to be shared, historical information, the action being performed (e-mailing, printing to a specific device, projecting on a specific device, et cetera) or a suitable combination of the foregoing.

To allow for analysis and identification of non-compliant content in the data to be shared, the input data coming from the interface is converted to a form that is interpretable by the content modification engine 250. An input content analyzer 251 extracts and converts the raw data provided by the interface, as described herein, to a form suitable for analysis. A basic form may be for example strings or phrases.

The input content analyzer 251 may utilize input (such as described above), user history, and/or regulatory policies to identify non-compliant content involved in a sharing action. The filter generator 252 may mark non-compliant content, along with reason(s) for the decision, for presentation to the user. Thus, output from system 100 may include a recommendation regarding the non-compliant content, which the user may either accept or reject, as discussed further herein.

The known policies and rules for information exchange (sharing) are stored in a database (such as 140), which could be in the form of a matrix, with one axis being the kind (content attribute values) of information and the other being the various ways in which information exchange can happen (medium). For example, whether a particular content type is allowed to be shared on a medium (for example, e-mail), is determined by such rules for each content type. Again, the set of rules invoked could be based on attributes (as captured by the interface 110) pertaining to the action, users (senders/recipients), devices, content and/or medium for the action performed.

Content attributes may include attributes to match the content being acted on to predetermined non-compliant content and for rule selection. This includes for example features in document attributes as well as features in actual content (embedded) of the document or data. Thus, certain keywords, formats, regular expressions and the like may be included in content attributes used for identifying non-compliant content and identifying rules for sharing such content.

User attributes may include information related to a user relevant for rule selection. For example, user access levels may be utilized in this regard. Several instances of rules could be slightly different for different user categories, such as a person who is temporarily on the payroll of company, but is originally sourced from another company, and thus may have different access and sharing allowances than a regular employee of the company. Thus, user access level may determine if any and/or some content may be shared on a particular medium, such as via e-mail.

User history may include information related to a user relevant for rule selection. For example, assuming a user has used the system 100 before and was served a warning or a recommendation, he or she could have checked the same with legal or any other source and overridden the recommendation of the system 100. In this case, the same recommendation should not come up again for the same or similar content for this user, or if it does, should also include the past action for convenient reference.

User preference may include information related to a user relevant for rule selection. For example, for a particular user, as well as other users, a preference history may be utilized in aiding appropriate rule selection, modification action(s) and/or recommendation(s). This may be implemented as a secondary set of rules with the priority order determined by actions of the user (or similar set of users) on a current document (or similar documents). Thus, a user history may indicate that this and/or other users have agreed to have a certain type of content masked such that the system implements the masking automatically. Contrarily, the user histor(ies) my indicate that a particular content type is not to be masked, but rather a privacy note should be added to the message prior to sharing the data.

Receiver characteristics may include information related to a user relevant for rule selection. For example, access/security clearance level(s) of a receiver may be leveraged in order to aid appropriate rule selection, modification action(s) and/or recommendation(s). Thus, the system 100 may implement different rules, for example depending on whether a recipient is internal to an organization or an outsider.

Document attributes may include information related to a document relevant for rule selection. For example, document attributes may include encryption, or lack thereof; password-protected, or lack thereof; restricted forwarding/sharing capability, marked as confidential, et cetera. Document attributes may include document properties that are extracted from file attributes/signatures, footnotes or other security attributes.

Thus, an embodiment analyzes the data, user(s), device(s), medium and the like to select appropriate rule(s) that drive the recommendation/modification implemented. Hence, if a two-dimensional table/matrix were constructed, as described herein, then each of the categories of user and receiver would have a separate matrix. Alternatively, a multi-dimensional matrix could include all or some combination of the attributes described herein.

As described herein, rule(s) may be inferred and/or extracted from any of the following sources or other like sources. Company policy documents stored in a database 140 may form the basis for rules. Company policy documents may be used for a one-time initialization done with manual supervision. Rules may also be extracted and/or inferred from prior content modification(s) done for action(s) on same/similar documents/content by same/similar users (sender/receiver). The compliance of a rule may be checked by first finding all the rules relevant to the action-content-sender-receiver-channel combination in question, and then detecting if any of them is violated. For example, a violation may include non-compliance with a rule regarding recipient access rights to a given piece of content. If found, a violation may then be presented to the user along with the matching keywords/attributes as a result of which the rule got invoked and the non-compliance identified.

As another example, certain content may not be suitable to be printed on a public printer, or a certain document containing confidential numbers may need to be suitably masked (for example, the confidential number rendered unreadable within the document) before being shared via e-mail with a business partner, and so on. For example, if a user initiates a print request on subset of slides in a POWERPOINT slide show presentation, if previously this user or other users have also filtered out the notes (for confidentiality reasons), a suggestion to filter out the same is made. The user may then agree to some or all of the suggestions and the corresponding modification(s). POWERPOINT is a registered trademark of Microsoft Corporation in the United States and other countries.

Using feedback provided by the user, the rules may be further refined with each piece of feedback available (for example, confirmation or rejection of the modification/recommendation by the user). This forms a feedback to the rules database, increasing the priority of the accepted rules.

As above, output from the example system 100 may include recommendation(s) for modification of content (such as masking or removing the non-compliant content identified) or the modification itself. If a user accepts the recommendation and/or modification, a new, modified content replaces the output for the original action.

Thus, the user is permitted to share the data as originally desired (for example, send the data via e-mail) subject to certain non-compliant content being modified. If the user rejects the recommendation/modification, then an alternative action may take place. For example, a privacy note may be attached to the original data indicating that confidential/sensitive content is contained within the data, or the action may be precluded subject to approval by management, et cetera.

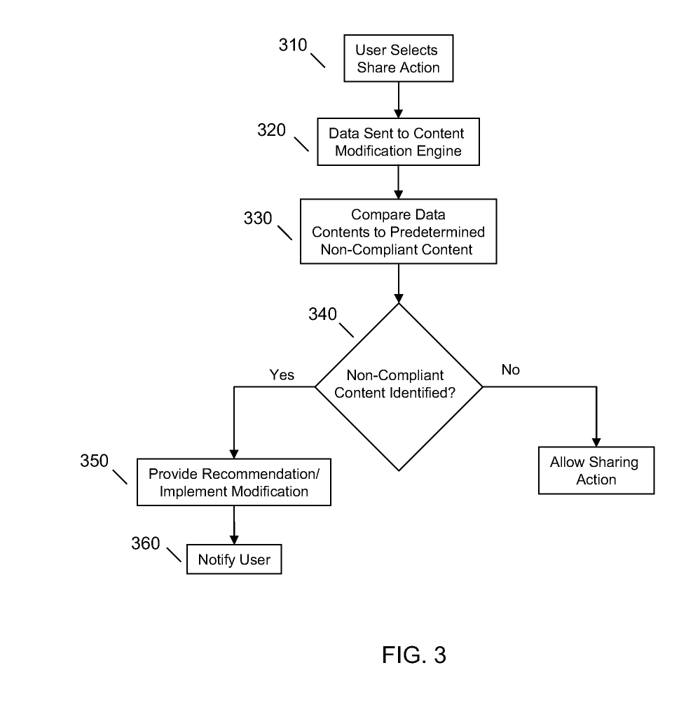

Referring to FIG. 3, an example method for identifying non-compliant content is illustrated. A user selects a sharing action at 310, such as hitting a “send” button in an e-mail client. The data to be shared is sent to the content modification engine at 320. For example, the data of the email, including attached document(s), is sent to the content modification engine. The content of the data is analyzed to compare it to predetermined non-compliant data according to rule(s) at 330. As described herein, the non-compliant data may be predetermined by matching content with users (sender/recipient), recipients, mediums or the like to extract rule(s) to handle the sharing action.

Some content may not have any rule associated with it, in which case the content will not be identified as non-compliant for the sharing action at 340. Similarly, some content will have rule(s) associated with it, but will comply with the rule(s), and thus this content will not be identified as non-compliant at 340.

However, some content may have rule(s) associated with it, and these rules may be violated by the selected sharing action. As such, this content will be identified as non-compliant at 340. For example, the user selecting the sharing action may be identified as a temporary employee. The data to be shared may include some confidential content. The destination address may be a precluded destination for the content to be shared, such as an outside email address.

Thus, a rule for such confidential content may state that only regular employees may send the content. Another rule for the content may state that only authorized, internal email addresses may receive the content. As such, the share selection violates these rules associated with the content. Thus, the content contained within the data (e-mail and attachment) is identified as non-compliant. Accordingly, an embodiment provides a recommendation (such as suggesting that the non-compliant content be masked or removed) or a modification (such as masking or removing the non-compliant content automatically) prior to allowing the sharing selection to be performed.

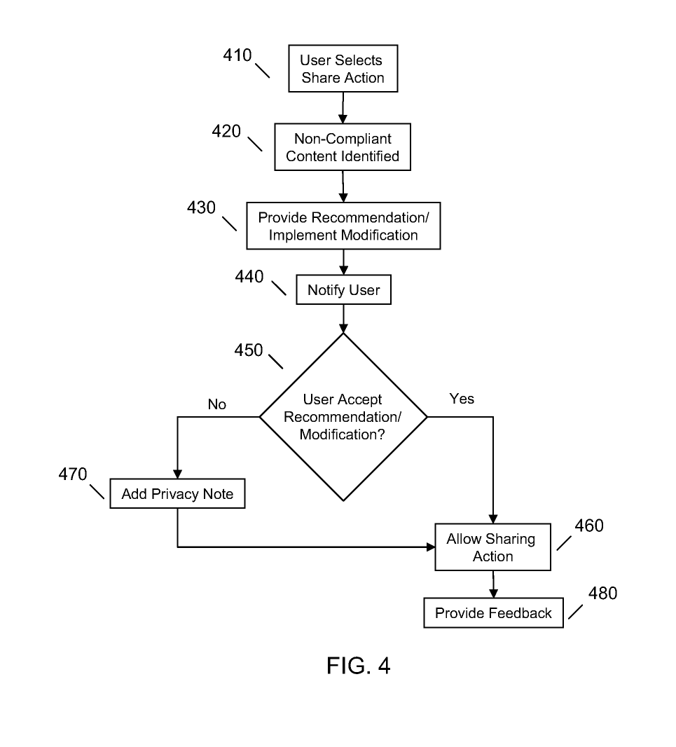

Referring to FIG. 4, an example method for sharing non-compliant content within data is illustrated. At 410, the user selects a sharing action for sharing some data. For example, the user clicks the “send” button in an e-mail application to send an e-mail and an attached document. At 420, non-compliant content has been identified within the data (e-mail and/or attachment(s)), as described herein. The content modification engine provides a modification and/or recommendation regarding the non-compliant content at 430, and provides a notification to the user at 440.

At 450, it is determined if the user accepted the modification and/or recommendation. If so, the sharing action may be allowed at 460, with the non-compliant content being conformed per the recommendation and/or modification. If the user does not accept the recommendation and/or modification, a privacy note may be added to the data at 470, for example the data is marked confidential. Once the privacy note is added at 470, an embodiment may permit the sharing action at 460. In either case, an embodiment may collect feedback at 480 regarding the user selection. Such feedback may be utilized in future identification of non-compliant content, future recommendations regarding non-compliant content, and/or future modifications for non-compliant content, or some suitable combination of the foregoing.

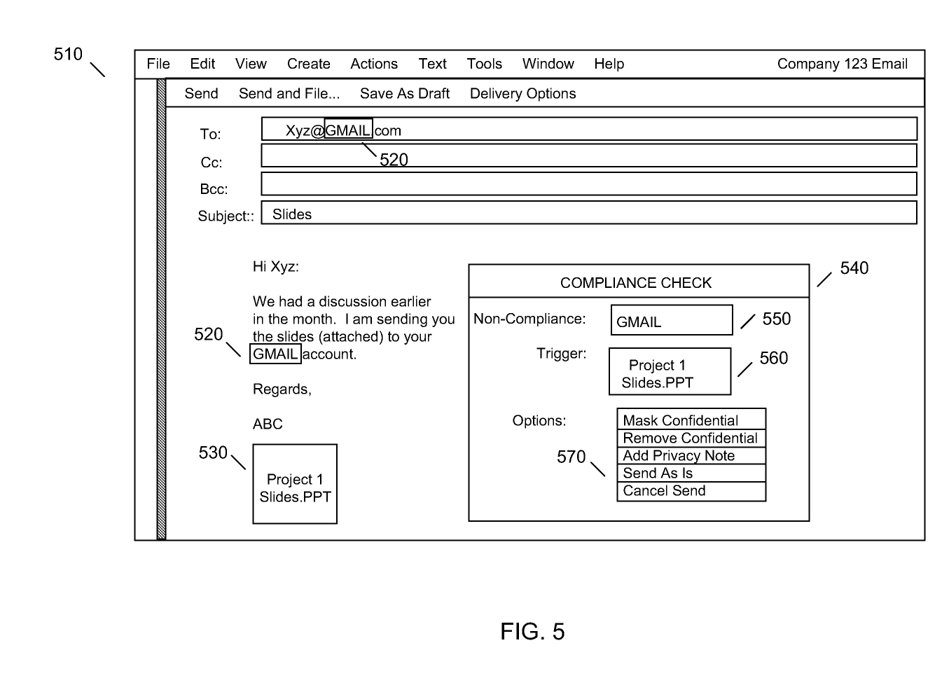

FIG. 5 illustrates a non-limiting example of identifying non-compliant content. As illustrated in FIG. 5, a user may attempt to send data in the form of an e-mail message and an attachment from an e-mail application 510. Prior to allowing the data to be sent to the recipient, the data is sent to the content modification engine, as described herein.

Given the content accessible to the content modification engine, the content modification engine may access a rule indicating that attachments having “Project 1” in the title 530 are not to be sent to outside e-mail addresses (other than “Company123” email addresses), for example to a GMAIL account. Since GMAIL 520 is contained in the address line (“To:”) and within the body of the email, the content modification engine may identify that the rule is potentially violated, that is, that non-compliant content 530 is potentially contained within the email based on the trigger 520 GMAIL. Thus, the content modification engine provides a notification of a rule violation to the user. The notification may take the form of a popup window 540 indicating the non-compliance 550 and non-compliant content 560, as well as options 570 for handling the non-compliant share request. GMAIL is a registered trademark of Google Inc. in the United States and other countries.

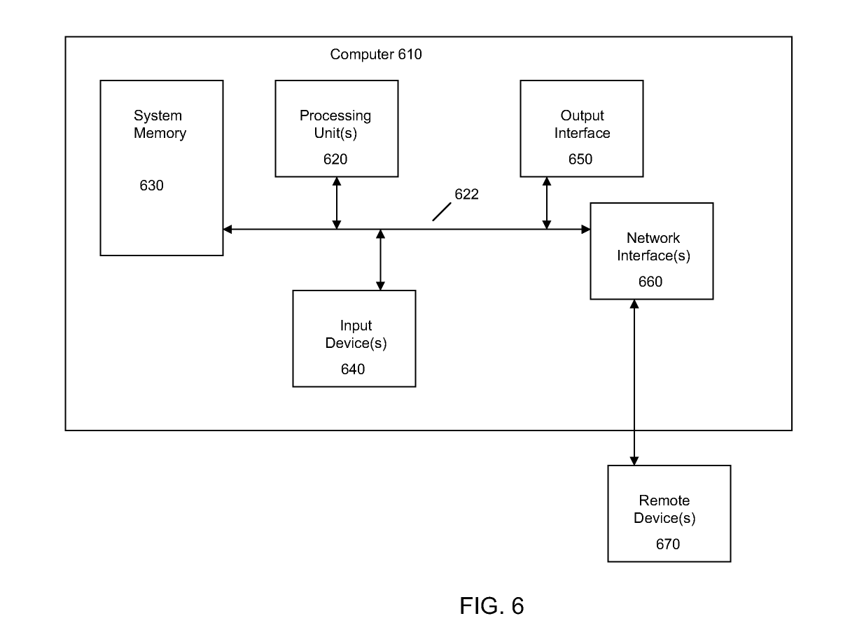

Referring to FIG. 6, it will be readily understood that certain embodiments can be implemented using any of a wide variety of devices or combinations of devices. An example device that may be used in implementing embodiments includes a computing device in the form of a computer 610, though other devices such as tablet devices, smart phones and the like are equally applicable. In this regard, the computer 610 may execute program instructions configured to provide automatic detection of non-compliant content in user actions, and perform other functionality of the embodiments, as described herein.

Components of computer 610 may include, but are not limited to, at least one processing unit 620, a system memory 630, and a system bus 622 that couples various system components including the system memory 630 to the processing unit(s) 620. The computer 610 may include or have access to a variety of computer readable media. The system memory 630 may include computer readable storage media in the form of volatile and/or nonvolatile memory such as read only memory (ROM) and/or random access memory (RAM). By way of example, and not limitation, system memory 630 may also include an operating system, application programs, other program modules, and program data.

A user can interface with (for example, enter commands and information) the computer 610 through input devices 640. A monitor or other type of device can also be connected to the system bus 622 via an interface, such as an output interface 650. In addition to a monitor, computers may also include other peripheral output devices. The computer 610 may operate in a networked or distributed environment using logical connections (network interface 660) to other remote computers or databases (remote device(s) 670). The logical connections may include a network, such local area network (LAN) or a wide area network (WAN), but may also include other networks/buses.

It should be noted as well that certain embodiments may be implemented as a system, method or computer program product. Accordingly, aspects may take the form of an entirely hardware embodiment, an entirely software embodiment (including firmware, resident software, micro-code, et cetera) or an embodiment combining software and hardware aspects that may all generally be referred to herein as a “circuit,” “module” or “system.” Furthermore, aspects may take the form of a computer program product embodied in computer readable medium(s) having computer readable program code embodied therewith.

Any combination of computer readable medium(s) may be utilized. The computer readable medium may be a non-signal computer readable medium, referred to herein as a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having at least one wire, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Program code embodied on a computer readable medium may be transmitted using any appropriate medium, including but not limited to wireless, wireline, optical fiber cable, RF, et cetera, or any suitable combination of the foregoing.

Computer program code for carrying out operations for various aspects may be written in any programming language or combinations thereof, including an object oriented programming language such as Java™, Smalltalk, C++ or the like and conventional procedural programming languages, such as the “C” programming language or similar programming languages. The program code may execute entirely on a single computer (device), partly on a single computer, as a stand-alone software package, partly on single computer and partly on a remote computer or entirely on a remote computer or server. In the latter scenario, the remote computer may be connected to another computer through any type of network, including a local area network (LAN) or a wide area network (WAN), or the connection may be made for example through the Internet using an Internet Service Provider.

Aspects have been described herein with reference to flowchart illustrations and/or block diagrams of methods, apparatuses, systems and computer program products according to example embodiments. It will be understood that the blocks of the flowchart illustrations and/or block diagrams, and combinations of blocks in the flowchart illustrations and/or block diagrams, can be implemented by computer program instructions. These computer program instructions may be provided to a processor of a computer or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer, or other programmable apparatus, provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Although illustrated example embodiments have been described herein with reference to the accompanying drawings, it is to be understood that embodiments are not limited to those precise example embodiments, and that various other changes and modifications may be affected therein by one skilled in the art without departing from the scope or spirit of the disclosure.

What is claimed is:

1. A computer program product comprising:
a computer readable storage medium having computer readable program code embodied therewith, the computer readable program code comprising:
computer readable program code configured to, responsive to receiving a user selection to share data, analyze the data to be shared; and
computer readable program code configured to automatically identify non-compliant content within the data prior to sharing the data.

2. The computer program product according to claim 1, further comprising computer readable program code configured to provide at least one recommendation for modifying the data prior to sharing the data.

3. The computer program product according to claim 2, wherein modifying the data prior to sharing the data comprises at least one of: masking the non-compliant content within the data, removing the non-compliant content within the data, and augmenting the data with a privacy note.

4. The computer program product according to claim 1, further comprising computer readable program code configured to use historical data to establish content defined as non-compliant content.

5. The computer program product according to claim 1, further comprising computer readable program code configured to use historical data to establish at least one recommendation for modifying the data prior to sharing the data.

6. The computer program product according to claim 2, further comprising computer readable program code configured to validate that the at least one recommendation complies with a policy associated with at least one type of non-compliant content contained within the data.

7. The computer program product according to claim 1, further comprising computer readable program code configured to automatically modify the data to conform the data to at least one policy.

8. The computer program product according to claim 7, wherein modifying the data to conform the data to at least one policy comprises at least one of: masking the non-compliant content within the data, removing the non-compliant content within the data, and augmenting the data with a privacy note.

9. The computer program product according to claim 1, further comprising computer readable program code configured to share the data according to the user selection responsive to modifying the non-compliant content within the data.

10. The computer program product according to claim 1, further comprising computer readable program code configured to ascertain feedback on a user action performed after the non-compliant content has been identified.

11. The computer program product according to claim 10, further comprising computer readable program code configured to use the feedback to provide at least one recommendation for modifying similar data prior to sharing the similar data.

12. The computer program product according to claim 1, wherein:
the data comprises an electronic document;
the non-compliant data comprises confidential information embedded within the electronic document; and
sharing comprises at least one of live sharing, printing, displaying, projecting, e-mailing, and instant messaging.

13. A method comprising:
responsive to receiving a user selection to share data via an electronic device, analyzing the data to be shared; and
automatically identifying non-compliant content within the data prior to sharing the data.

14. The method according to claim 13, further comprising providing at least one recommendation for modifying the data prior to sharing the data.

15. The method according to claim 14, wherein modifying the data prior to sharing the data comprises at least one of: masking the non-compliant content within the data, removing the non-compliant content within the data, and augmenting the data with a privacy note.

16. The method according to claim 13, further comprising using historical data to establish content defined as non-compliant content.

17. The method according to claim 13, further comprising using historical data to establish at least one recommendation for modifying the data prior to sharing the data.

18. The method according to claim 14, further comprising validating that the at least one recommendation complies with a policy associated with at least one type of non-compliant content contained within the data.

19. The method according to claim 13, further comprising automatically modifying the data to conform the data to at least one policy.

20. The method according to claim 19, wherein modifying the data to conform the data to at least one policy comprises at least one of: masking the non-compliant content within the data, removing the non-compliant content within the data, and augmenting the data with a privacy note.

21. The method according to claim 13, further comprising sharing the data according to the user selection responsive to modifying the non-compliant content within the data.

22. The method according to claim 13, further comprising ascertaining feedback on a user action performed after the non-compliant content has been identified.

23. The method according to claim 22, further comprising using the feedback to provide at least one recommendation for modifying similar data prior to sharing the similar data.

24. The method according to claim 13, wherein:
the data comprises an electronic document;
the non-compliant data comprises confidential information embedded within the electronic document; and
sharing comprises at least one of live sharing, printing, displaying, projecting, e-mailing, and instant messaging.

25. A system comprising:
at least one processor; and
a memory device operatively connected to the at least one processor;
wherein, responsive to execution of program instructions accessible to the at least one processor, the at least one processor is configured to:
responsive to receiving a user selection to share data, analyze the data to be shared; and
automatically identify non-compliant content within the data prior to sharing the data.
